(19) United States
(12) Patent Application Publication
(10) Pub. No.: US 2009/0192915 A1
(43) Pub. Date: Jul. 30, 2009

(54) METHODS OF ASSOCIATING A PURCHASE BY A CLIENT WITH A CONTENT PROVIDER WHICH FACILITATED THE PURCHASE BY THE CLIENT

(75) Inventor: Alvaro FERNANDEZ, Barcelona (ES)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Media Patents, Barcelona (ES)

(21) Appl. No.: 12/388,513

(22) Filed: Feb. 18, 2009

Related U.S. Application Data
(63) Continuation of application No. PCT/ES2009/070011, filed on Jan. 28, 2009.

(30) Foreign Application Priority Data
Jan. 30, 2008 (ES) P200800238

(51) Int. Cl. G06Q 30/00

(52) U.S. Cl. 705/26

(57) ABSTRACT

A method of associating a particular purchase with a content provider includes the step of receiving first data from the content provider after a client selects a reference which is provided at the content provider and is associated with a particular entity. The first data includes first information which identifies the content provider, second information which is associated with the particular entity, and third information which is associated with the client. The method also includes the step of receiving second data from the particular entity after the client purchases a good or service, or both, associated with the particular entity. The second data includes fourth information which is associated with the client. Moreover, the method includes the steps of determining that the client which selected the reference is associated with the client which made the purchase based on the third information and the fourth information, and associating the purchase with the content provider based on the first data and the second data.

### CROSS-REFERENCE TO RELATED APPLICATION

The present application claims priority from Patent Cooperation Treaty Application No. PCT/ES2009/070011, which was filed on Jan. 28, 2009, and claims priority from Spanish Patent Application No. P200800238, which was filed on Jan. 30, 2008, the disclosures of which are incorporated herein by reference in their entirety.

### BACKGROUND OF THE INVENTION

1. Field of invention

The present invention is related generally to methods of associating a purchase of at least one good or at least one service, or both, by a client with a content provider which facilitated the purchase by the client. In particular, the present invention is directed towards methods in which a client selects a reference, e.g., an advertising link associated with a seller, such as a merchant or a service provider, or both, at the content provider, the content provider transmits first information which is associated with the client and which identifies the content provider to an intermediary, and when the client subsequently purchases the at least one good or the at least one service, or both, from the seller, e.g., using the Internet, a telephone Network, a facsimile Network, or the like, the seller transmits second information which is associated with the client to the intermediary, and based on at least a portion of the first information and at least a portion of the second information, the intermediary determines that the client which selected the reference is the associated with the client which made the purchase, and consequently, the content provider is associated with the purchase. The content provider then may be compensated for facilitating the purchase by the client, and the intermediary may be compensated for determining that the content provider is associated with the purchase.

2. Description of Related Art

Entities which advertise on the Internet and sell goods or services, or both, attempt to ensure that their Web sites readily may be accessed by users which may be interested in the goods or services, or both, offered by the entity.

A known method for attracting potential buyers to a Web site is to advertise on search engines. This method allows the advertiser to target a segment of the public, such that the entity chooses the keywords and which of its advertisements will appear. When a user performs a search on an Internet search engine and enters text which includes one of the selected keywords for one or more advertiser, the search engine displays those advertisements to the user. In this method, the advertisers have tools which assist them in managing their campaigns. For example, the AdWords® system from the Google® search engine allows the advertisers to choose the price which they are willing to pay for each selection made by a user on their advertisements depending on the keyword chosen, and shows them information regarding the number of times their advertisements have been shown, the number of times their advertisement has been selected, and the Click Through Rate (“CTR”) which is the number of times users select an advertisement divided by the number of times the advertisement has been displayed to users. AdWords® also provides information with respect to the average position at which each advertisement is displayed to users. This data may be relevant to advertisers because users tend to select advertisements which are displayed at upper positions more often than advertisements which are displayed at lower positions.

Another known method for attracting potential buyers is to advertise goods or services, or both, on Web sites whose content attracts users who are interested in a specific topic. Such Web sites may include theme Web sites on videogames, cinema, music, computer programs, or the like. Advertisements may be provided in the form of a link which, when selected by the user, directs the user to the advertiser's Web site. In this method, the advertiser pays the content Web sites compensation based on the number of times the advertiser's link is selected by users. Nevertheless, in this known method, the advertiser must be in contact with the content Web sites, and must organize the way in which the content Web sites display the advertisement links and the way in which the content Web sites receive compensation.

Another known method which addresses these issues is the AdSense® system from the Google® search engine, which is described in Patent Application Publication Nos. US 2004/0093327 and US 2004/0059708, and in U.S. Pat. No. 5,948,061. This known system allows any Web site to include third-party advertisers and to receive a payment for it. The advertisers who use this system may include their advertisements in Google's® “search network” or “content network.” The “search network” is a collection of Web sites which display the Google® search window, which may be used to perform a search in the same way as the search window on the Google® search engine Web site. When performing a search, a list of normal or “organic” results and a list of advertisements presented as “sponsored links” are displayed. The “content network” is a collection of Web sites where the advertisements are published by entities whose goods are related to the content. The AdSense® system analyzes the content of the Web sites willing to host advertisements, and decides which of these Web sites are the most suitable for each advertisement. The advertisements include a link to the advertiser's Web site. Each time a user selects one of the advertisements, the owner of the hosting Web site receives a payment from the advertiser.

This known method has the advantage of allowing the entities to advertise on Web sites whose content is related to their goods, which increases the likelihood that user's viewing the advertisement may be interested in the goods or services, or both, associated with the advertisement. Nevertheless, in this known method, the advertisement-hosting Web site owners are compensated based on the number of times that the advertisements are selected. Therefore, in this known method, there is an incentive for advertisement-hosting Web site owners to select their own web site advertisements in order to increase the amount of their compensation. Moreover, there is incentive for one entity to repeatedly select another entity's advertisement to cause the advertising entity to quickly spend their budget allocated for that advertisement. These issues may hinder both the advertisers and the advertisement-hosting Web site owners. Consequently, many advertisers either do not use this known system or are not willing to pay a substantial amount of compensation for advertisements displayed under this system.

Another problem for advertisers in the known advertising methods is that there are substantial number of advertisers competing to display their advertisements in the top positions, which raises the rate per user selection for the keywords which are requested the most often by the advertisers. Some search engines use an online auction system and display the advertisements of those advertisers who offer to pay the greatest amount of compensation for each keyword.

Other search engines display the advertisements of those advertisers who generate the largest income for the search engine. Specifically, the search engine's profitability depends not only on the price per user selection paid by the advertiser, but also on the price multiplied by 100 times the CTR factor. For example, if two advertisers display their advertisements when a user enters the word “lawyer” in an Internet search engine, under the condition that Advertiser 1 pays 5 units per user selection and has a CTR of 1.0% and Advertiser 2 pays 3 units per user selection and has a CTR of 5%, then the Internet search engine will be paid 100×(1.0%)×5 units=5 units from Advertiser 1, and 100×(5%)×3 units=15 units from Advertiser 2. Therefore, Advertiser 2's advertisement most likely appear before that of Advertiser 1 because Advertiser 2's advertisement generates more income for the Internet search engine.

Another known problem to advertisers in the known methods is that advertisers generally fix a budget for their campaigns and manage their campaigns according to the results obtained, e.g., the sales generated from the campaigns. This implies a risk for the advertisers because their campaigns may lose revenue for the advertiser if the campaigns do not generate enough revenue, and the advertisers may not be able to accurately estimate their revenue until they have enough experience with the campaigns.

Other known systems, such as the systems described in U.S. Pat. Nos. 5,991,740 and 6,029,141, address this issue by using affiliate or associate Web sites. The affiliate Web sites charge the advertisers a commission on the sales which are generated by the user selecting the advertisements on the affiliate Web sites. With these known systems, the advertisers are not at financial risk because they only pay a commission on the sales generated by each associated site.

One known problem associated with these known systems is that only may be applied to Web sites at which transactions are carried out. Nevertheless, a substantial percentage of businesses do not have transactional Web sites which allow their clients to make purchases via the Internet. For example, a services entity, such as a law firm, may not use these known systems to advertise because its Web site generally does not allow transactions. Moreover, a substantial portion of businesses do not have transactional Web sites, and they cannot measure their advertisements' profitability in this way, as users do not carry out any transactions during their visit to the Web Site. In many economical transactions, personal contact and trust between the people involved are important, and Internet sales systems are not adequate for those kinds of economic transactions. Generally, these kind of businesses have a Web site with a purely informative purpose, aiming to encourage the visitors to make personal contact, via e-mail, telephone, facsimile, or the like, with the entity that owns the Web site. For example, a person looking to purchase a house generally prefers to visit the house before purchasing the house. Similarly, people who want to hire a services entity, such as a lawyers or an architect, generally prefer to meet with or otherwise be in contact with a representative of the service entity before making any monetary payment to the service entity.

Another known problem associated with these known systems is that most transactional Web sites are not configured to operate with a transaction monitoring system in which a user visit to the transactional Web site originated at an affiliate Web site, and the affiliate Web site is compensated if the user visit to the transactional Web site results in a sale via the Internet. For example, banks and airlines generally have Web sites at which clients may carry out transactions, however, these Web sites generally do not include a system for monitoring the Web sites at which the visit originated because there is no standard system capable of monitoring the affiliate Web site, which also allows the affiliate Web site to control the profitability obtained during the visits generated by the affiliate Web site.

Referring to FIG. 1, a known transactional system 100 is depicted. In system 100, an equipment 152 uses a communication 101 to communicate with an advertising site 120 using Hypertext Transfer Protocol (“HTTP”). An HTTP protocol generally uses several TCP/IP Internet connections (not shown). The equipment 152 may be a PC, a PDA, a mobile phone with browser, or any other equipment that supports the use of an Internet browser.

Similarly, a communication 102 is used for communication, through the HTTP protocol, between the equipment 152 and an intermediate system 180. A communication 103 shows communication through the HTTP protocol between the equipment 152 and a selling Web site 132.

A Web site may be formed by a series of equipment coupled to the Internet, among which there is a Web site server. The system 180 also may be formed by a set of equipment coupled to the Internet, and may also include a Web site server.

The communication between the different Web sites in FIG. 1 may be carried out using different technologies or communication protocols, such as HTTP, Web services, Simple Object Access Protocol (“SOAP”) objects, Transmission Control Protocol/internet Protocol (“TCP/IP”) connections, or any other communication method between networks. The HTTP protocol is the one used by browsers, while Web services are protocols used to establish communication between applications which communicate over the Internet. Due to the substantial diffusion of the HTTP protocol, it is also used as a low-level protocol on which some Web services work, such as SOAP.

The advertising Web site 120 contains a Web page 123 with two advertisements in the form of links 121 and 122. When the browser 151 access the Web page 123, and one of the links 121 or 122 is selected, the browser uses the HTTP protocol to access the URL Web site associated with the link to display the new Web site. This way, the user may browse different Web sites, selecting different links, each of which has an associated URL.

The link 122 has an associated URL, which leads to a virtual store's Web page 131 from the vendor Web site 132, where the user at the equipment 152 may make a purchase via the Internet. In system 100, the Web site 132 may detect, using one of three different, possible systems, which is the referring Web site 120 which led the user to the virtual store, and may monitor the user's transaction at the transactional Web site 132 to compensate the referring Web site 120 for the transaction. The following are the three systems which may be used in system 100 to send to the vendor Web site 132 the information 129 which identifies which is the advertising Web site 120 that generated the visit.

Because the advertising Web site 120 and the selling Web site 132 do not establish a direct TCP/IP connection, there must be some indirect mechanism to send the Web site 132 the information 129 which identifies the Web site 120. The three different systems use different properties of the HTTP protocol to send the information 129 to the Web site 132.

The first system, such as the system described in U.S. Pat. No. 6,029,141, transmits the information 129 as a URL parameter of the link 122 which leads the Web site 120 user towards the Web site 132. The URL 104 containing the information 129 is sent from the Web site 120 to the browser 151 in the equipment 152, and the browser 151 transmits the URL 104 and the information 129 to the Web site 132 using the HTTP protocol to access the Web site 132. The information 129 also may identify which is the advertisement which the user selected, such that the Web site 132 receives the information that identifies that good and may directly display the information on that good to the user when they access the Web site, thus saving the user the need to navigate the vendor Web site 132 to find that information.

The second system, such as the system described in U.S. Pat. No. 5,991,740, uses an intermediary system 180 that goes between the advertising Web site 120 and the selling Web site 132. When the user selects the link 121, they are directed to the intermediary Web site 180, and from there, they are redirected to the selling Web site 132. Before redirecting the user, the intermediary system 180 saves the information 129 in a cookie 105, and sends it to the equipment 152. In the virtual store 131, there is a final Web page the user reaches after the transaction is complete. In that Web site, there is a link to the element 189 coming from the intermediary site 180's Web server. This element may be, for example, an image, text, or a non-visible image. When the user's browser 151 uses the HTTP protocol to read the final page, it has to enter the intermediary site using the HTTP protocol to obtain the element 189, and at that time, the cookie 105 with the information 129 is sent to the intermediary site's Web server.

The third system, such as the system described in Patent Application Publication No. US 2007/0050245, uses a browser property consisting of identifying the Web site of origin when the user visits a Web site coming from another Web site. This system is relatively simple, and works in about 95% of browsers.

Nevertheless, may not be used in non-transactional Web sites as none of these systems may be used outside the HTTP protocol. Moreover, the system based on cookies, only may work if the browser and the equipment used to visit the Web page 123 and the virtual store 131 are the same.

### SUMMARY OF THE INVENTION

Therefore, a need has arisen for methods of associating a purchase of at least one good or at least one service, or both, by a client with a content provider which facilitated the purchase by the client, which overcome these and other shortcomings of the related art. A technical advantage of the present invention is that when a client selects a reference, e.&., an advertising link associated with a seller, at a content provider, the content provider or the browser transmits first information which is associated with the client and which identifies the content provider to an intermediary, and when the client subsequently purchases the at least one good or the at least one service, or both, from the seller, e.g., using the Internet, a telephone Network, a facsimile Network, or the like, the seller transmits second information which is associated with the client to the intermediary, and based on at least a portion of the first information and at least a portion of the second information, the intermediary determines that the client which selected the reference is the associated with the client which made the purchase, and consequently, the content provider is associated with the purchase independent of how the client makes the purchase.

According to an embodiment of the present invention, a method of associating a particular purchase with a content provider comprises the step of receiving first data from the content provider or from the browser after a client selects a reference which is provided at the content provider and is associated with a particular entity. The first data comprises first information which identifies the content provider, second information which is associated with the particular entity, and third information which is associated with the client. The method also comprises the step of receiving second data from the particular entity after the client purchases at least one good or at least one service, or both, associated with the particular entity. The second data comprises fourth information which is associated with the client. Moreover, the method comprises the steps of determining that the client which selected the reference is associated with the client which purchased the at least one good or the at least one service, or both, based on the third information and the fourth information, and associating the purchase of the at least one good or the at least one service, or both, with the content provider based on at least one portion of the first data and at least one portion of the second data.

Other objects, features, and advantages of embodiments of the present invention will be apparent to persons of ordinary skill in the art from the following description of preferred embodiments with reference to the accompanying drawings.

### BRIEF DESCRIPTION OF THE DRAWINGS

For a more complete understanding of the present invention, the needs satisfied thereby, and the objects, features, and advantages thereof, reference now is made to the following description taken in connection with the accompanying drawings.

FIG. 1 is a schematic diagram of a known system for associating a particular purchase with a content provider.

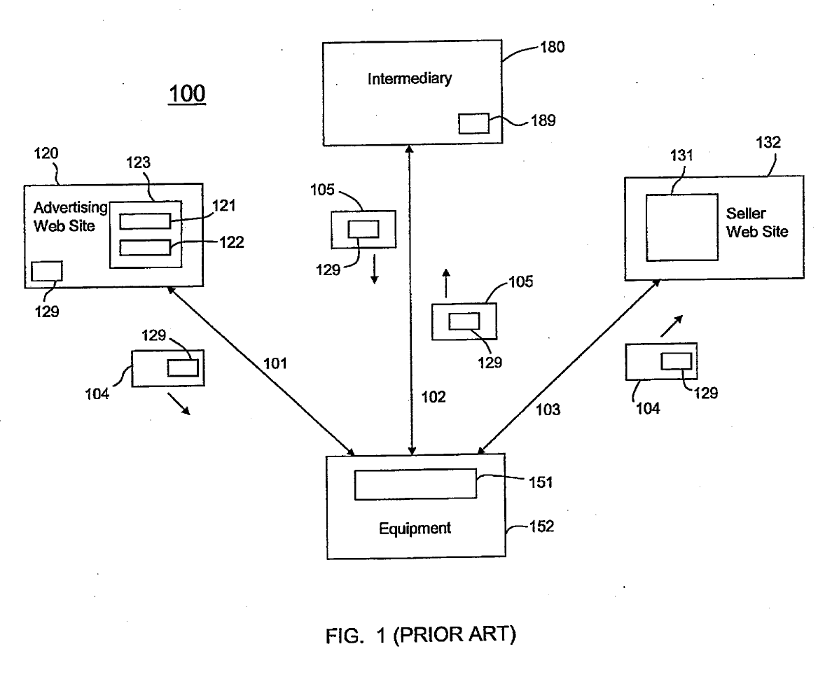

FIG. 2 is a schematic diagram of a system for associating a particular purchase with a content provider, according to an embodiment of the present invention.

FIG. 3 is a schematic diagram of a system for associating a particular purchase with a content provider, according to another embodiment of the present invention.

FIG. 4 is a schematic diagram of a system for associating a particular purchase with a content provider, according to yet another embodiment of the present invention.

### DETAILED DESCRIPTION OF EMBODIMENTS

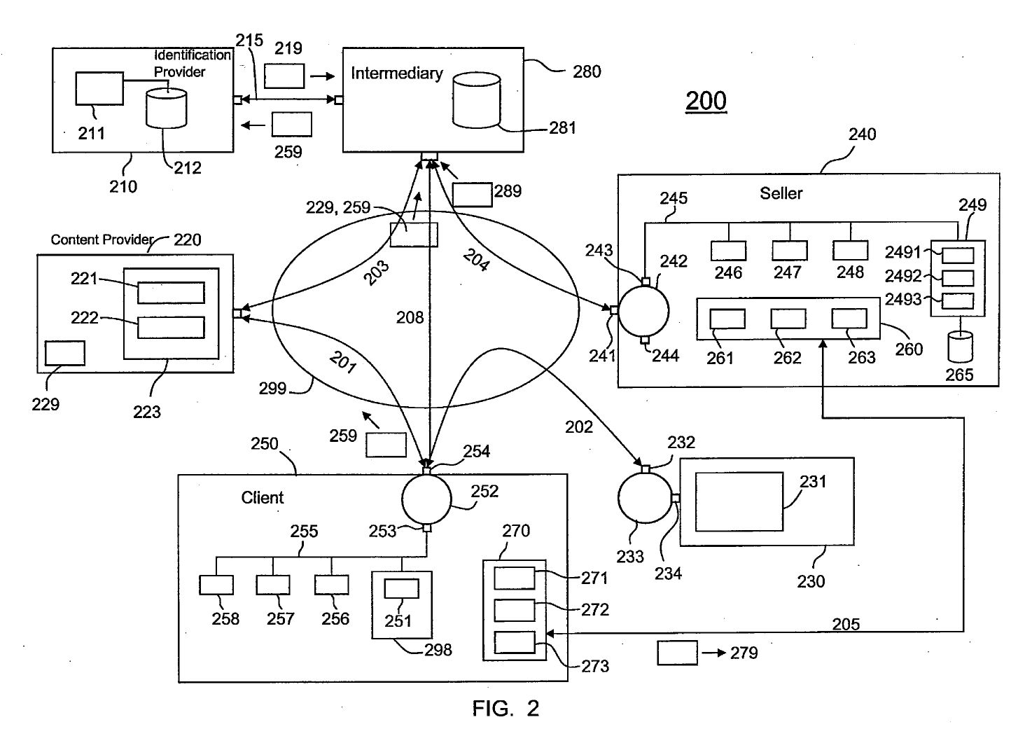

Embodiments of the present invention and their features and technical advantages may be understood by referring to FIGS. 2-4, like numerals being used for like corresponding portions in the various drawings.

Referring to FIG. 2, a system 200 for associating a particular purchase with a content provider, according to an embodiment of the present invention, is depicted. A seller 240 may comprise, e.g., may have access to, media 260. Media 260 may not be coupled to the Internet, and may comprise a facsimile Network or a telephone Network, or both. The facsimile Network may comprise a fax machine 261, and the telephone Network may comprise a telephone line 262 or a mobile phone 263.

The seller 240 also may comprise a data network 245, such as an Ethernet Network, coupled to a router 242. The router 242 may comprise a plurality of network interfaces 241, 243, and 244. For example, the network interface 243 may couple the data network 245 to the router 242, and the network interface 241 may couple the router 242 to an external data network, such as the Internet 299.

The seller's data network 245 also may be coupled to a computer 246, a voice over IP (“VoIP”) system 247 which allows establishment of telephone communications on the external network 299, an e-mail application 248 which allows sending and receiving e-mails, and an application server 249.

The application server 249 may comprise a Customer Relationship Management (“CRM”) 2493 application, an Enterprise Resource Planning (“ERP”) 2492 application, and an Application Program Interface API 2491.

A selling Web site 230 may be associated with seller 240. In FIG. 2, selling Web site 230 is depicted as being separate from seller 240 because entities generally hire external Web servers for their Web sites. Nevertheless, other configurations are possible. For example, selling Web site 230 may be included in seller 240, or the router 233 may be coupled to the router 242.

The client 250 may comprise media 270, and media 270 may comprise a facsimile Network and a telephone Network. For example, the facsimile Network may comprise a fax machine 271, and the telephone Network may comprise a telephone line 272 and a mobile phone 273. The client 250 also may comprise a data network 255 coupled to Internet 299 through a router 252 and a network interface 254. The data network 255 may comprise a first computer 298 comprising a browser 251, a second computer 256, a VoIP system 257, and an e-mail system 258 which allows the sending and receiving of electronic mail.

When the user of first computer 298 uses the browser 251 to visit a Web page 223 of a content provider Web site 220, e.g., an advertising Web site, and selects a link 221 (or a link 222), the user is directed to the selling Web site 230 and, at the same time, the content provider site 220 or the computer 298 sends data comprising information 229 and information 259 to the intermediary system 280. For example, the content provider Web site 220 or the browser 251 may execute a JavaScript program or a JavaScript code which carries out the above-described functions when the client 250 activates the link 221. Communication between the various equipment of system 200 via the Internet may be accomplished via communications 201, 202, 203, 204 and 208. The intermediary system may receive the data comprising information 229 and information 259 via communication 203 or via communication 208 depending where the JavaScript code is executed.

The information 229 received by the intermediary system 280 may comprise a unique identifier for the content provider site 220; a “TimeStamp” field indicating the moment, e.g., the day, the time, the minute, the second, the fraction of second, or the like, when the client 250 selected the link 221; and an “AdvertisementID” field that identifies the advertisement which the user selected. With this identifier, the intermediary system 280 knows the identity of the content provider 220 and the goods or services, or both, associated with the link 221 selected by the client 250.

The information 259 received by the intermediary system 280 comprises information associated with the media used by the client 250 to access the Web page 223. For example, information 259 may comprise the IP address and the TCP/IP connection port used by the browser 251 to access the Web page 223. When the router 252 uses Network Address Translation (“NAT”) or Network Address Port Translation (“NAPT”) technologies, which are used to exchange the data network 255's internal IP addresses with public IP addresses that may be used in the data network, then the IP address sent in the information 259 is that of the public IP.

Thus, the client visits the seller's Web page 231 using the browser 251, and information 259 which is associated with the media used by the client 250 is sent to the intermediary system 280 along with information 229 which identifies the content provider site 220 and the link 221 selected by the user at the content provider 220.

The information 259 which the content provider 220 or the browser 251 sends to the intermediary system 280 may allow the intermediary system to access the identity of the client 250. For example, the intermediary system 280 may transmit the information 259 to an identification provider 210 via the communication 215, and may receive data comprising information 219 which identifies the client 250 or is unique for the client 250. Information 219 may be stored in a database 281.

Subsequently, the client 250 enters into a commercial transaction with the seller. The transaction may be made using one or more of media 270 or first computer 298.

The transaction entered into via media 270 is represented by the line 205 coupling the client's media 270 with the seller's media 260. It may be a purchase done by phone, fax, or a visit to the seller's store. In entering this transaction, client 250 transmits data comprising information 279 to the seller 240, such that the seller 240 may issue the corresponding invoice for the goods or services purchased by the client 250.

The information 279 which is used to issue invoices may be unique to the client 250 or may identify the client 250, or both. These information 279 may comprise the client's name, address, telephone number, postal code, or town, or any combination thereof

In another embodiment, the invoice may comprise alphanumeric information which identifies the client 250. For example, in Europe the code called Value Added Tax (“VAT”) number is widely used. The first two letters in the VAT number indicates the European country where the client 250 lives, and the remainder of the code is a number which identifies each client 250 within each European country.

Regardless of whether the information 279 comprises an alphanumeric code which by itself identifies the client 250, the information 279 may identify the client 250 in a unique manner. In the first case, the alphanumeric codes are designed for the purpose of uniquely identifying the client 250. In the second case, the information also may uniquely identify the client 250 because it is unlikely that two entities or two individuals that have the same name also may have the same address, town, postal code, and the like. Therefore, the information 279 may allow the client 250 to be identified in a unique manner.

The seller 240 has an application server 249 that executes the CRM 2493 and ERP 2492 applications used to issue an invoice to client 250. Client 250's information 279 is introduced in those CRM 2493 and ERP 2492 systems, and that information is stored in the database 265.

The CRM systems may be used to manage relationships with clients 250. Their basic functions are to store information on clients 250 and the communications with them, such as phone calls made and received, to monitor offers made to the clients 250, and to manage “leads” or sales opportunities.

The ERP systems are systems that manage an entity's resources, such as employees, warehouses, spare parts, inventories, invoices, and the like. A CRM's functionality may overlap that of an ERP because their scopes are not well defined. For example, an invoice for a client may be made with either a CRM or an ERP. There are in the market programs that join both functionalities in a single application, and other systems in which the CRM is first a module and the ERP is a second module, and both modules are integrated.

There also are available in the market CRM and ERP systems that are not executed in the client's equipment but rather are installed in external servers, and the client uses them via the Internet on a browser, paying a monthly fee. These systems that may be used via the Internet save the client from the work related to their installation, configuration, and maintenance. In FIG. 2, the CRM 2493 and ERP 2492 applications are executed in an application server coupled to the seller 240's Intranet. Nevertheless, other configurations are possible. The ERP 2492 and CRM 2493 may be executed in external servers and communicated with the API 2491 via Internet.

In application server 249, an application API 2491 is executed, which may communicate with the ERP 2492 and CRM 2493 systems and may have access to the database 265. The API application may access to the information 279, and may transmit data comprising information 289 to intermediary 280. Information 289 may be unique to client 250, may identify client 250, or both. The information 289 also may comprise information associated with the purchase made by the client 250, such as the total amount of the purchase or information identifying the goods or services purchased by the client 250.

The information 289 may or may not be intelligible. For example, information which is unique to a client and is not intelligible is a Hash. A Hash is a function or a method to generate keys that represent a document, registry, file, or the like. A hash is the result of such function or algorithm. In those countries of the European Union, there are laws that limit the transmission of personal data, and for this reason, it is convenient that system 200 may work with information that is unique for the clients 250, but that do not identify the clients 250, using, for example, hash functions for each portion of the clients' 250 information, e.g., name, address, town, and the like.

The intermediary system has information 219 and 289 which are unique for the client 250 or identify the client 250. For example, information 219 may be sent by identification provider 210, and information 289 may be sent by the API 2491.

When the information 219 and 289 are intelligible information which identify the client in a unique manner, the intermediary system 280 looks for matches between the information 219 and 289 to establish that the client 250 which purchased the good or service from the seller 240 corresponds to the as the client which selected the link 221. To establish that match, it is not necessary that all of the fields match, and the intermediary system 280 may establish the match using only a few fields, like the VAT number.

In an embodiment, system 200 standardizes the clients' addresses to make the comparison. To this end, it has a database of countries, towns and streets. This standardization may take place in the applications on the server 249, in the identification provider 210, or on the intermediary site 280.

This way, the intermediary system 280 establishes that the client 250 who has made a purchase using media 270 corresponds to the client 250 which selected the link 221, and it may send this information, both to the content provider 220 and to the seller 240, which enable the seller 240 to compensate the content provider 220 for the sale facilitated by the link 221. That compensation may be made through the intermediary system 280.

The identification provider 210 may be a telecommunications entity which provides Internet access to the client 250. The telecommunications entity may comprise a system 211 which has access to each client's information, grants the client 250 Internet access, and store information on the client 250 in a database 212. For example, the system 211 may comprise an Authentication, Authorization and Accounting (“AAA”) server, such as RADRIS, which controls the Internet access of each of their clients 250 and stores that information in the database 212, which also may be used to charge for the services the telecommunications entity gives to its clients 250.

Because the system 211 controls the clients' 250 Internet access, the telecommunications entity knows which are the media used by the client 250 to access Internet, like each client's public IP address at any time.

The identification provider 210 receives information 259 from the intermediary system 280, including information on the media used by the client 250, such as the IP address, and sends to the intermediary system 280 information 219 which identifies the client 250 or, in case the information is sent in a confidential manner, which is unique to the client 250.

The system 200 also may work with information 219 and 289 which are unique for the client 250 and do not identify the client 250 in an intelligible way. In this example, it is sufficient to standardize each of the fields which identify the client 250 and apply to a Hash function to each of them.

The identification provider 210 is shown in FIG. 2 as separated from the intermediary system 280. Nevertheless, other configurations are possible. For example, those systems could be a single system. This would, for example, allow an entity working as both an intermediary system and as an identification provider to offer free Internet access to its clients in exchange for receiving a commission on the purchases those clients made in stores whose Web sites they would have visited using the Internet connection this entity had granted them.

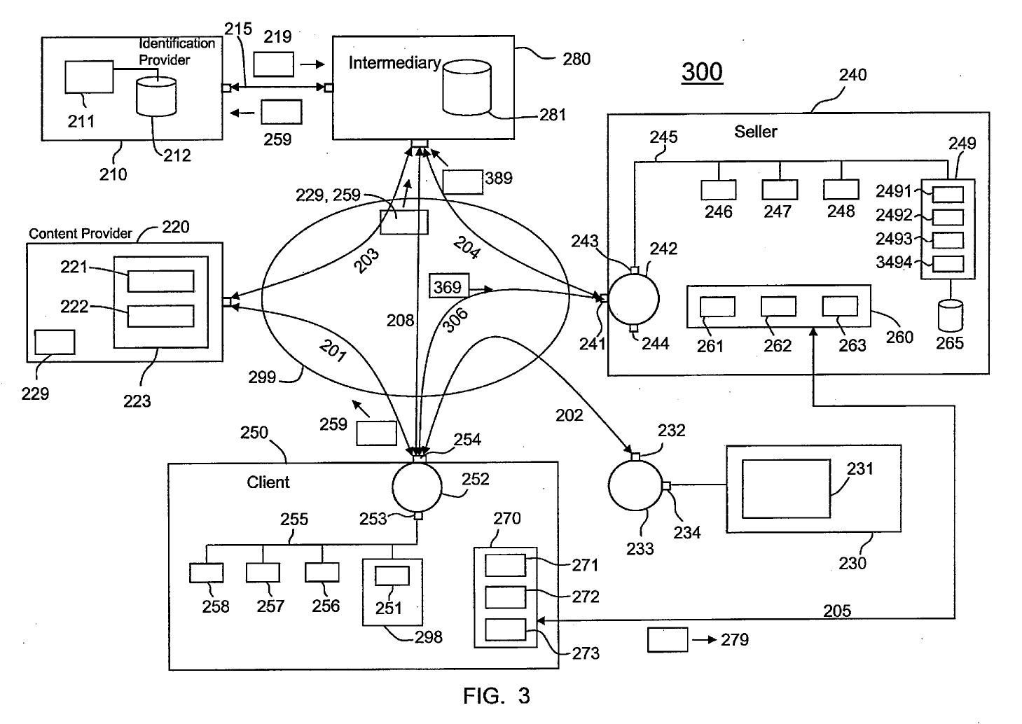

Referring to FIG. 3, a system 300 for associating a particular purchase with a content provider, according to another embodiment of the present invention, is depicted. System 300 may be substantially similar to system 200. Therefore, only those difference between system 200 and system 300 are described with respect to system 300. In system 300, a communication 306 between the client 250 and the seller 240 may takes place through the Internet 299.

FIG. 3 shows how both the seller 240 and the client 250 may comprise equipment coupled to the networks 245 and 255, respectively, and the equipment may be used to communicate via Internet. In particular, the seller 240 may comprise VoIP system 247 and e-mail system 248. The client 250 also may comprise VoIP system 257 and e-mail system 258.

The communication 306 between seller 240 and client 250 may be, for example, a telephone call using VoIP technology, from the VoIP systems 247 and 257, seller's and client's respectively. It also may be an e-mail communication between the e-mail systems 248 and 258.

E-mail communication between sellers and clients is quite common. As telephony systems evolve, communication between VoIP systems also may become more frequent.

In addition, with the evolution of the IPv4 protocol to IPv6, there no longer may be a shortage of IP addresses to be assigned to the users, and each equipment of each user may have its own IPv6 address that will identify its communications in a unique way.

In both cases, when a direct communication 306 is established between the seller 240's and the client 250's equipments, the API 2491 receives information 369 on the media used by the client 250 for the communication 306, for example, the IP address used by client 250. For this, the API 2491 receives the information 369 from the VoIP system 247 or from the e-mail system 248, and it stores this information 269 in the database 265, so that it is accessible for the CRM 2493 and the ERP 2492.

Nevertheless, in FIG. 3, the purchase is not made in an online store. The purchase may be made through the online communications 306, like an e-mail or a telephone purchase using VoIP, or from the media 270.

This way, the CRM 2493 and the ERP 2492 store in the database 265, along with the client information, other information 369 associated with the media and electronic equipment each client 250 uses.

The API 2491 sends information 389 unique for the client 250 to the intermediary system 280, which may comprise information based on the information 369, e.g., the EP address used by the client 250.

This way, the intermediary system 280 receives information associated with equipment used by the client 250 both from the content provider 220 (information 259) and from the seller 240 (information 389), and the intermediary system 280 determines whether the client 250 who has made a purchase from the seller 240 has previously selected the link 221.

In case the client 250 uses an external e-mail server, the API 2491 may discover the client's IP address by sending an e-mail to the client 250 with a link to a Web page that could, for example, display the invoice, and thus, monitoring the IP address used by the browser to access the Web page comprising the invoice. The Web server showing that Web page may be, for example, an application 3494, executed in the server 249.

In this way, the system 300 allows establishing a relation between the client 250 who has selected the link 221 and the client who has made a purchase by a phone call using the VoIP technology, or an e-mail message, or any other online communication between the client 250 and the seller 240, and without the seller 240 needing to have an online store.

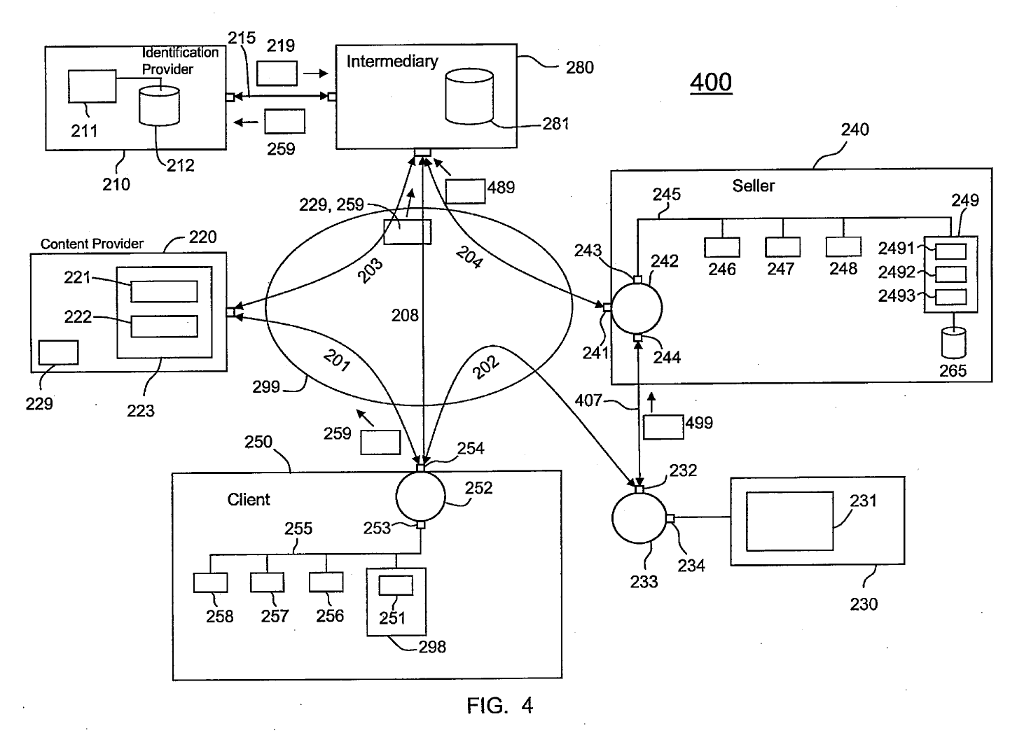

Referring to FIG. 4, a system 400 for associating a particular purchase with a content provider, according to yet another embodiment of the present invention, is depicted. System 400 may be substantially similar to system 200. Therefore, only those difference between system 400 and system 200 are described with respect to system 400. In system 400, client media 370 and seller media 360 have been omitted, and the client 250 makes a purchase at the selling Web site 230's virtual store 231.

The virtual store 231 detects information on the media used by the client 250 to carry out the purchase, such as their TP address, and sends information 499 to the seller 240's API 2491 through a communication 407.

The information 499 may comprise a detailed description of the purchase made by the client 250, along with information on the media used by the client 250 when carrying out the purchase in the virtual store. The API 2491 stores that information in the database 265.

Later, the API 2491 sends information 489, which is unique for the client 250, to the intermediary system 280. The intermediary system 280 previously received information 259 from the content provider 220. This way, the intermediary system 280 may establish which are the links 221 that the client 250 has selected to reach the virtual store 231 where they have made an online purchase, even if the client 250 used different computers to select the link 221 and to make the purchase in the virtual store. For example, the client 250 may use the computer 298 to select the link 221, then subsequently may use the computer 256 to carry out the purchase in the virtual store 231.

In each of systems 200, 300, and 400, the intermediary system 280 may establish time limits for each of links 221 and 222. Those time limits may be used to establish the relationship between selected link and the purchases made. For example, there may be a relationship between the link 221 and the purchase of a good advertised on the Web page 231 when the purchase has been made within a predetermined amount of time, e.g., three months, of the client 250 selecting the link 221.

Another application of systems 200, 300, and 400 is that they may be used as an online publicity system not based on commissions, but instead, based on pay-per-click or pay-per-print. Specifically, the sellers advertising online may monitor the sales generated by each publicity link selected, and thus, measure the profitability of their publicity campaigns in a more detailed way than with the known systems.

Another application of systems 200, 300, and 400 may be a combination of the former two application. For example, a seller pays for their advertisements by means of a commission on sales, and an advertising site charges a fee per clicked-on advertisement. For this, the intermediary system has the statistical information that allows it to relate the selecting on publicity links with the actual sales, and also to establish the fee per click or per print of every advertising link in each advertising site, in relation with the sales each link generates in each advertising site.

While the invention has been described in connection with various exemplary structures and illustrative embodiments, it will be understood by those skilled in the art that other variations and modifications of the structures and embodiments described above may be made without departing from the scope of the invention. Other structures and embodiments will be apparent to those skilled in the art from a consideration of the specification or practice of the invention disclosed herein. It is intended that the specification and the described examples are illustrative with the true scope of the invention being defined by the following claims.

What is claimed is:

1. A method of associating a particular purchase with a content provider, comprising the steps of:
receiving first data after a client selects a reference which is provided at the content provider and is associated with a particular entity, wherein the client selects the reference using a first type of Network, and the first data comprises:
first information which identifies the content provider;
second information which is associated with the particular entity; and
third information which is associated with the client;
receiving second data from the particular entity after the client purchases at least one good or at least one service, or both, associated with the particular entity, wherein the client purchases the at least one good or the at least one service, or both, using a second type of Network which is different than the first type of Network, and the second data comprises fourth information which is associated with the client;
determining that the client which selected the reference is associated with the client which purchased the at least one good or the at least one service, or both, based on the third information and the fourth information; and
associating the purchase of the at least one good or the at least one service, or both, with the content provider based on at least one portion of the first data and at least one portion of the second data.

2. The method claim 1, wherein the third information comprises information associated with a media used by the client to access the content provider.

3. The method of claim 2, wherein the reference is provided at a web page associated with the content provider, and the client comprises a browser, wherein the media comprises an Internet Protocol address used by the browser of the client to access the web page associated with the content provider.

4. The method of claim 3, further comprising the steps of:
transmitting the third information to an identification provider; and
receiving fifth information from the identification provider, wherein the fifth information is associated with and is unique to the client, and the first data further comprises the fifth information, wherein the at least one portion of the first data comprises the first information, the second information, and the fifth information.

5. The method of claim 3, further comprising the steps of:
transmitting the third information to an identification provider; and
receiving fifth information from the identification provider, wherein the fifth information identifies the client, and the first data further comprises the fifth information, wherein the at least one portion of the first data comprises the first information, the second information, and the fifth information.

6. The method of claim 3, further comprising the step of determining fifth information based at least on the third information, wherein the fifth information is associated with and is unique to the client, and the first data further comprises the fifth information, wherein the at least one portion of the first data comprises the first information, the second information, and the fifth information.

7. The method of claim 3, further comprising the step of determining fifth information based at least on the third information, wherein the fifth information identifies the client, and the first data further comprises the fifth information, wherein the at least one portion of the first data comprises the first information, the second information, and the fifth information.

8. The method of claim 2, wherein the fourth information comprises at least one of a name associated with the client, a telephone number associated with the client, and an address associated with the client.

9. The method of claim 8, wherein the reference is provided at a web page associated with the content provider, and the client comprises a browser, wherein the media comprises an Internet Protocol address used by the browser of the client to access the web page associated with the content provider.

10. The method of claim 1, wherein the first type of Network comprises the Internet, and the second type of Network does not comprise the Internet.

11. The method of claim 10, wherein the second type of Network comprises one of a telephone Network and a facsimile Network.

12. The method of claim 1, further comprising the steps of:
after associating the purchase of the at least one good or the at least one service, or both, with the content provider, transmitting an identity of the content provider to the particular entity; and
receiving compensation from the particular entity, wherein the compensation is associated with the transmission of the identity of the content provider to the particular entity.

13. The method of claim 1, further comprising the steps of:
after associating the purchase of the at least one good or the at least one service, or both, with the content provider, transmitting compensation to the content provider.

14. The method of claim 13, further comprising the steps of:
after associating the purchase of the at least one good or the at least one service, or both, with the content provider, transmitting an identity of the content provider to the particular entity; and
receiving compensation from the particular entity, wherein the compensation is associated with the transmission of the identity of the content provider to the particular entity.

15. The method of claim 1, wherein the reference comprises a Uniform Resource Locator of a Web page associated with the particular entity.

16. The method of claim 15, wherein the client purchases the at least one good or the at least one service, or both, at the Web page associated with the particular entity.

17. A method of associating a particular purchase with a content provider, comprising the steps of:
receiving first data after a client selects a reference which is provided at the content provider and is associated with a particular entity, wherein the client selects the reference via the Internet, and the first data comprises:
first information which identifies the content provider;
second information which is associated with the particular entity; and
third information which is associated with the client;
receiving second data from the particular entity after the client purchases at least one good or at least one service, or both, associated with the particular entity, wherein the client purchases the at least one good or the at least one service, or both, at a physical location associated with the particular entity, and the second data comprises fourth information which is associated with the client;
determining that the client which selected the reference is associated with the client which purchased the at least one good or the at least one service, or both, based on the third information and the fourth information; and
associating the purchase of the at least one good or the at least one service, or both, with the content provider based on at least one portion of the first data and at least one portion of the second data.
